(19) United States
(12) Patent Application Publication
(10) Pub. No.: US 2014/0297338 A1
(43) Pub. Date: Oct. 2, 2014

(54) System and Method for Optimizing Ticket Cost over a Travel Itinerary

(71) Applicant: Moonyoung Kang, Cambridge, MA (US)

(72) Inventor: Moonyoung Kang, Cambridge, MA (US)

(21) Appl. No.: 13/854,989

(22) Filed: Apr. 2, 2013

(51) Int. Cl. G06Q 10/02

(52) U.S. Cl. CPC G06Q 10/02
USPC 705/5

(57) ABSTRACT

A system and method that optimize ticket cost given a travel itinerary. With the information of tourist attractions the user wants to visit, group of people the user is traveling with, and the schedule of the trip, such as the start and end date and time of the trip, the system builds a travel itinerary that optimizes user's budget. The system considers various conditions of the traveler and co-travelers, such as age, status, and trip schedule of the traveler, to find the cheapest ticket combination over multiple tourist attractions the traveler plans to visit. By properly parsing open hours of each tourist attraction and ticket, the system automatically considers availability of each tourist attraction and ticket given the traveler's tour schedule.

### BACKGROUND

The present invention is in the technical field of tourism. More particularly, the present invention is in the technical field of information technology and tourism. More particularly, the present invention is in the technical field of travel information management system. More particularly, the present invention is in the technical field of travel itinerary creator.

Traditional guidebooks and travel information websites provides information of tourist attractions, accommodations, restaurants, and transports but these information are often atomized. It is not easy to gather atomized information to form a well-organized trip itinerary over multiple attractions through multiple days that optimizes on traveler's cost.

For instance, imagine a tourist visiting five tourist attractions in New York City (NYC): Empire State Building Observatory, American Museum of Natural History, The Metropolitan Museum of Art, The Museum of Modern Art, Top of the Rock, and Circle Line Cruise. The tourist may buy admission tickets at the ticket office of each attraction, assuming this is the only possible way. However, after a little search, the tourist finds that there are many better options.

For instance, New York City Pass (NYCP) offers a combo ticket over six major attractions in NYC at a discounted price by 46%. NYCP is a good option if a tourist is visiting all six attractions, however, not if visiting only a few attractions among six, or if the tourist is a student. NYCP is a fixed-price ticket regardless of how many attractions a tourist visits, and the tourist won't benefit much if not visiting all six listed attractions. Also, if the tourist is a student, buying a student ticket at each attraction may give more discounts, because there is no student discount with NYCP.

Furthermore, other types of admission tickets might give better bargain. New York Pass (NYP) provides a combo ticket to over 20 attractions at a discounted price as long as the tourist visits these attractions within several consecutive days. Also, some tourist attractions provide ‘free entry’ on certain days, and some other tourist attractions offer discounted tickets for groups and families.

### SUMMARY

The present invention is a computerized travel itinerary creator which helps users to build a personalized travel itinerary. With the user's choice of tourist attraction to visit, expected start/end date of the trip, and some information of the people whom the user is traveling with, the system finds the cheapest set of tickets to buy that covers selected tourist attractions at the lowest cost while satisfying constraints of attractions and tickets.

### BRIEF DESCRIPTION OF THE DRAWING

FIG. 1 is a block diagram, showing a possible network environment of the present invention.

FIG. 2 is a domain model, showing a possible data structure of the present invention.

FIG. 3 is a flowchart, showing overall algorithm of the invention.

FIG. 4 is a flowchart, showing algorithm of Attraction Ranking Module 311 of FIG. 3.

FIG. 5 is a table, showing an example tourist attractions' open hours text in normalized form.

FIG. 6 is a pseudocode, describing open hours parsing algorithm.

FIG. 7 is a visualization, showing the execution of pseudo code in FIG. 6 using open hours text O4 522 in FIG. 5.

FIG. 8 is a table, showing the ticket optimization problem from the viewpoint of weight set cover problem.

FIG. 9 is a chart, showing the ticket optimization problem over multiple people, based on the ticket optimization with single person in FIG. 8.

FIG. 10 is a table, showing how semaphores can be used to define tickets.

FIG. 11 is a chart, showing how semaphores are processed when calculating optimal ticket set.

FIG. 12 is a table, showing real-world example of a type 1 group ticket in generalized form. Given a number k, type 1 group ticket gives admission to covered attratoms to only k people and neither more nor less than k people.

FIG. 13 is a table, showing how a type 1 group ticket in FIG. 12 can be converted into a system-understandable form.

FIG. 14 has theorems and proofs, showing that real-world type 1 group ticket in FIG. 12 and system-understandable group ticket in FIG. 13 are mathematically identical.

FIG. 15 is a table, showing real-world example of a type 2 group ticket in generalized form. Given a number k, type 2 group ticket gives admission to covered attratoms to k people and possible to more than k people with additional fee.

FIG. 16 is a table, showing how a type 2 group ticket in FIG. 15 can be converted into a system-understandable form.

FIG. 17 is a table, showing real-world example of a select-N ticket in generalized form. Select-N ticket gives admission to one of its attratoms when purchased.

FIG. 18 is a table, showing how a select-N ticket in FIG. 17 can be converted into a system-understandable form.

FIG. 19 is a tree, showing an example pigeon hole tree given the start and end date of a trip.

FIG. 20 is a set of algorithms, showing how value of each node of pigeon hole tree is initialized.

FIG. 21 is an algorithm, showing how a lowest pigeon hole covering a time span can be found.

FIG. 22 is a set of definitions, which is used in the following figures.

FIG. 23 is a table, showing real-world example of a time-dependent ticket in generalized form.

FIG. 24 is a table, showing how a time-dependent ticket in FIG. 23 can be converted into a system-understandable form.

FIG. 25 has assumptions, theorems, and proofs, showing that real-world time-dependent ticket in FIG. 23 and system-understandable time-dependent ticket in FIG. 24 are mathematically identical.

FIG. 26 is a table, showing real-world example of a day-pass ticket in generalized form.

FIG. 27 is a table, showing how a day-pass ticket in FIG. 26 can be converted into a system-understandable form.

FIG. 28 is a chart, showing an example of optimization problem over multiple people with trip-member independent tickets and semaphores.

FIG. 29 is a table, showing an example of optimization problem over multiple people after incorporating trip-member information into tickets and attratoms from FIG. 28.

FIG. 30 is an equation, showing how the set of tickets and attratoms in FIG. 29 can be converted into a integer linear programming equations.

### DETAILED DESCRIPTION OF THE INVENTION

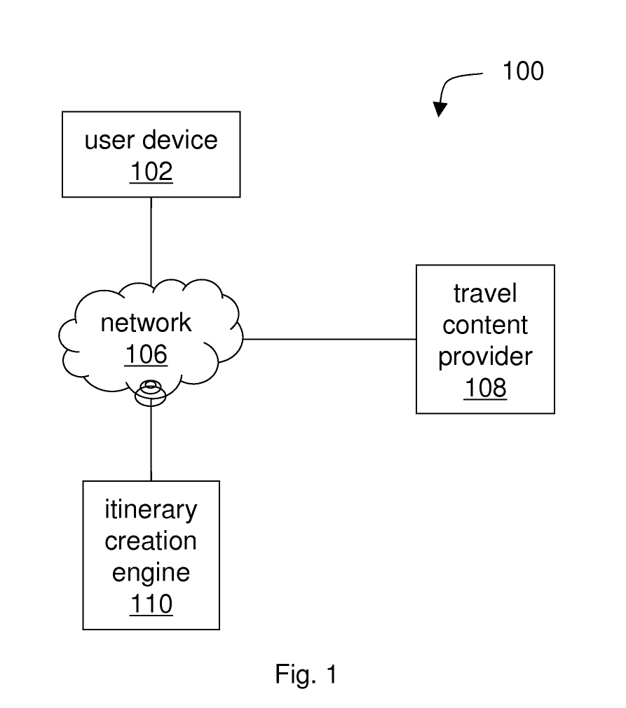

Referring now to the invention in more detail, FIG. 1 illustrates the network environment 100 which might be employed in an embodiment of the invention. A user of the system might access the travel itinerary creation engine 110 using the user interface 102 through the network 106. The user interface 102 can be a desktop computer, a hand-held device, a cell phone, or a software programmed to communicate with a travel itinerary creation engine 110. A travel itinerary creation engine 110 may comprise hardware, such as a RISC machine, or software executed on a computing machine or machines, such as desktop PC, server, or server farm. A system administrator may use the user device 102 to update the data in travel itinerary creation engine 110 using information from external travel content provider 108. A content provider 108 may be a source of travel information in any format, such as tourist attractions' website, databases, user input, and etc. The itinerary creation engine 110 may update data automatically using information from content provider 108.

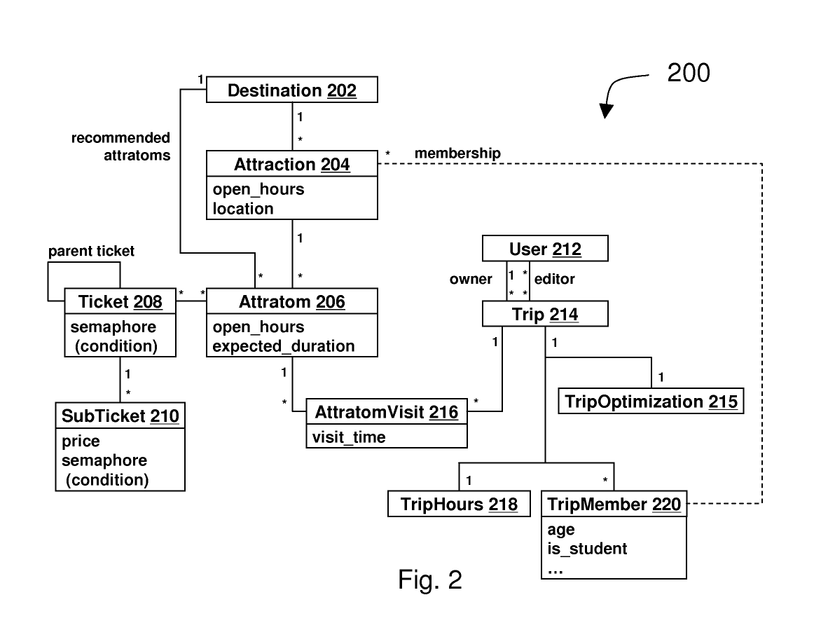

FIG. 2 illustrates domain model 200 of core parts of the system. The model is presented to help explain the algorithms and concepts of the system. The implementation of the idea does not have to be based on this domain model in FIG. 2 specifically.

A Destination 202 is a region that travelers may want to visit, such as the New York City or the Niagara Falls. A Destination 202 is often a city, but can be a region, such as the Yellowstone National Park or the Grand Canyon National Park.

An Attraction 204 is a tourist attraction, such as the Empire States Building (ESB) observatory, the Top of the Rock observatory, or the Statue of Liberty, which people want to visit. An Attraction 204 belongs to a Destination 202.

An Attraction 204 may have two attributes, open_hours and location. Open_hours attribute defines when the Attraction 204 is open. Location attribute defines where the Attraction 204 is located, by longitude and latitude in our system, but may change later. Location attribute can help the system to cluster Attractions 204 that are close to each other or easy to visit together.

Unlike common belief that an Attraction 204 is an indivisible single entity, an Attraction 204 often comprises of multiple subparts. For instance, as in Table 1, ESB comprises of three sub-services: 86th Floor observatory, 102nd Floor observatory, and Express pass. To deal with this discrepancy, we define each subpart of an Attraction 204 as an Attratom 206. An Attraction 204 is divided into Attratoms 206 when there is a Ticket 208 that can purchase only a part of the Attraction 204. For instance, in Table 1, ESB has four Tickets 208: 86th Floor ticket, 102nd Floor ticket, 86th & 102nd Floor ticket, and 86th & 102nd Floor ticket, and these tickets shatters ESB Attraction 204 to three subparts: 86th Floor, 102nd Floor, and express pass, each of which becomes an Attratom 206. Naturally, an Attratom 206 belongs to a single Attraction 204. A Destination 202 may have relation to a set of Attratoms 206 under the name of ‘guide’, which comprises Attratoms 206 that are frequently visited by travelers in the Destination 202.

An Attratom 206 may have two attributes: open_hours and expected_duration. Open_hours defines the open hours of an Attratom 206, same as the open_hours attribute in an Attraction 204. If an Attratom 206 has no open_hours attribute defined, it inherits the attribute value from the parent Attraction 204. Expected_duration defines the time a person is expected to stay during the visit to the Attratom 206.

An Attratom 206 has a single ‘open hours’. Tourist attractions with different open hours are modeled as two different Attratoms 206. For instance, each of “Radio City tour” and “Top of the Rock observatory (TOTR)” will be modeled as an Attratom 206 since their open hours do not match and there are tickets that cover only one of the two tourist attractions.

A Ticket 208 is an admission ticket to one or more Attratoms 206. A Ticket 208 and an Attratom 206 have a many-to-many relations; a Ticket 208 might cover more than one Attratom 206 and more than one Ticket 208 can grant admission to an Attratom 206. For example, an ESB 86th & 102nd floor observatory ticket covers two attratoms: ESB 86th floor observatory and ESB 102nd floor observatory. At the same time, ESB 86th floor observatory can be covered by many different tickets: ESB 86th floor observatory ticket, ESB 86th floor observatory ticket for child, ESB 86th & 102nd floor observatory ticket, and etc.

A Ticket 208 has semaphores for its attribute, which defines conditions the Ticket 208 can be used. For instance, MoMA offers free entry on Fridays after 3 pm, and semaphore is used to constraint the time that a “free entry” ticket can be used. A Ticket 208 may have a parent ticket if information from other ticket is necessary for implementation.

A SubTicket 210 is a sub-concept of a Ticket 208. Some tickets have identical coverage of tourist attractions with different prices and conditions. For instance, adult, student, and senior tickets usually have same tourist attraction coverage, but different prices and conditions of whom can buy each ticket. In such case, a Ticket 208 is defined to cover tourist attractions, more specifically, Attratoms 206, while SubTickets 210 are defined to model each price and condition of tickets. For instance, ESB has 86th floor ticket for adult, child, and senior and these tickets share tourist attraction coverage but price and purchase condition of each ticket is different. In this case, our system creates a Ticket 208 object for the tourist attraction coverage, and three SubTickets 210 are created as children of the Ticket 208: one for adult, one for child, and one for senior. A SubTicket 210 relates to a single parent Ticket 208, and there can be no two Tickets 208 object with identical Attratom 206 coverage.

A SubTicket 210 has two attributes: price and semaphore. Price attribute defines the price of a SubTicket 210. Semaphore attribute defines the condition that the ticket can be used. For instance, an ESB 86th floor for child SubTicket 210 has semaphore that checks the age of the user.

A User 212 is a user to the system. A User may be created explicitly by a user or implicitly by the system when required. A Trip 214 defines a trip. Currently, our system defines a Trip 214 to be related to a single Destination 202 only for easy implementation but this relationship is not necessary conceptually. A Trip 214 makes two types of relations with a User 212: owner and editor. An owner can add or remove another User 212 as the editor of the Trip 214. An editor can modify the related Trip 214 object. A Trip 214 has one-to-one relationship to TripOptimization 215 object which caches the optimized result of the Trip 214.

Trips 214 and Attratoms 206 have many-to-many relation through AttratomVisit 216. AttratomVisit 216 defines Attratoms 206 planned to visit in a Trip 214. An AttratomVisit 216 has a visit_time attribute, which defines when the related Attratoms 206 will be visited during the Trip 214.

TripHours 218 defines the schedule of a Trip 214 in a list of start/end time pairs, for instance, from 2012.09.05 11:00 to 2012.09.07 22:00, from 2012.10.11 07:00 to 2012.10.14 17:00, and from 2012.11.19 12:00 to 2012.11.27 07:00.

TripMember 220 defines members of a Trip 214, and defines the people participating in the Trip 214. TripMember 220 has attributes, such as age and is_student, which are used to determine whether each TripMember 220 satisfies conditions defined by Semaphores in Ticket 208 and SubTickets 210.

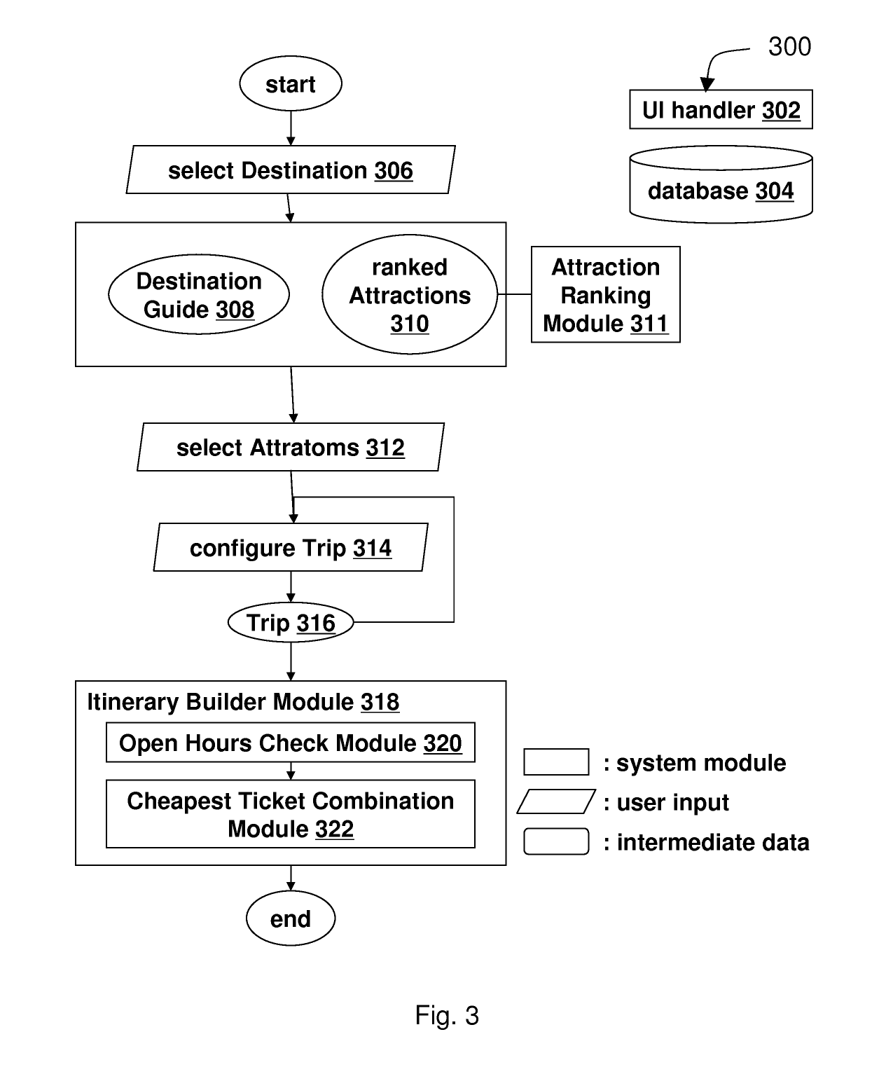

FIG. 3 illustrates a simple possible embodiment of the itinerary creation engine 110 that provides a travel itinerary to the user. All the interaction with a User 212 will be through a UI handler 302 and related data will be fetched from pre-built database 304 or similar data handling hardware or software. In step 306, User 212 starts the process by selecting a Destination 202 the user wants to travel. From the selected destinations, the Attraction Ranking Module 311 generates ordered list of ranked Attractions 310 with regard to popularity of Attractions 204 and User's 212 preference.

Ordered list of Attractions 204, not Attratoms 206, is provided to Users 212 because people generally think of an Attraction 204 as a single indivisible tourist attraction as mentioned previously. Attratoms 206 are nested in the list of Attractions 204, and Users 212 select Attratoms 206 to visit in the next Trip 214. Selected Attratoms 312 are added to a new Trip object 316. Alternatively, User 212 can select Attratoms 206 from a Destination Guide 308, which holds list of Attratoms 206 frequently traveled by Users 212. This process is iterative and user can continuously add, remove, or modify Attratoms 206 in the Trip 316.

After the configuration 314, Scheduling Module 318 will run Open Hours Check Module 320 and Cheapest Ticket Combination Module 322. Open Hours Check Module 320 checks whether all the Attratoms 206 can be visited during the Trip's 316 TripHours 218 using Attraction 204 and Attratom's 206 open_hours attribute. Attratoms 206 that cannot be visited during current Trip 316 will be removed from further process. Cheapest Ticket Combination Module 322 fetches SubTickets 210 that covers any selected Attratom 206 of the Trip 316 and finds the cheapest SubTicket 210 combination which covers all the selected Attratoms 206. More details of each module will be described in the following sections.

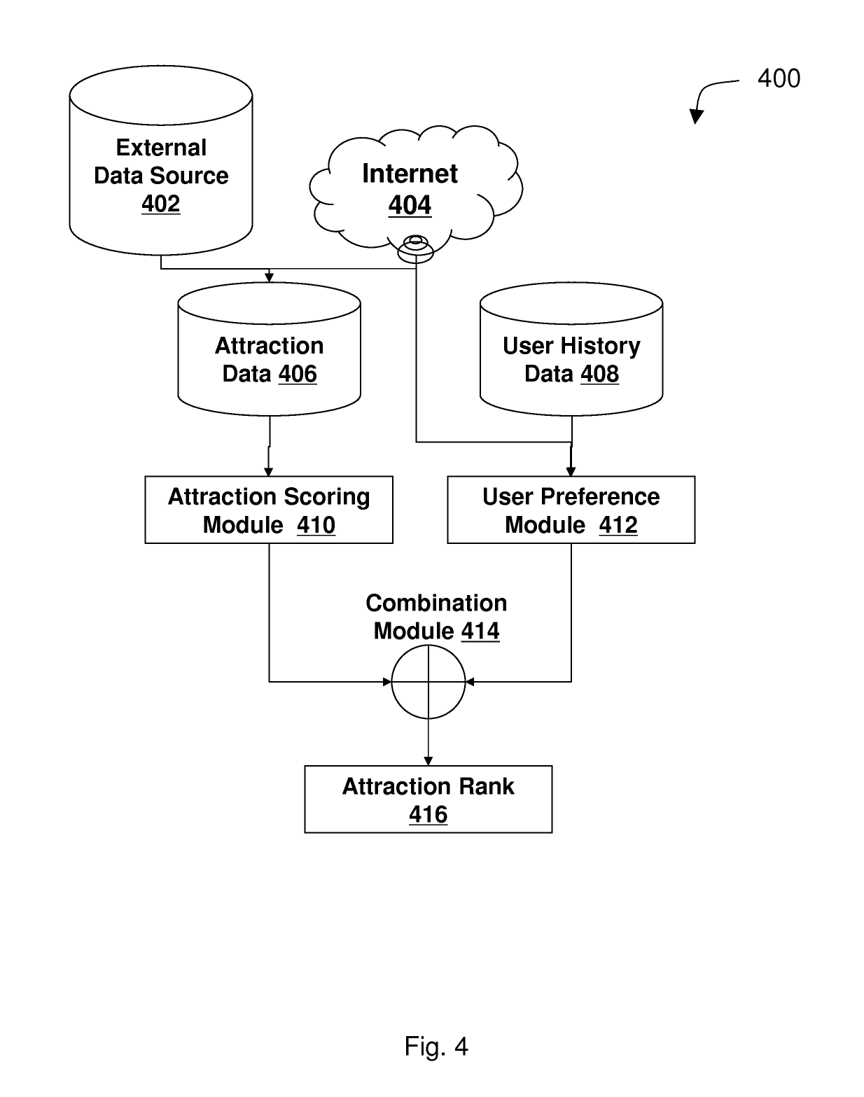

FIG. 4 describes the Attraction Ranking Module 311. Attraction Ranking Module 311 scores an Attraction 204 using two sub-modules: Attraction Scoring Module 410 and User Preference Module 412. Attraction Scoring Module 410 scores and ranks Attractions 204. System collects information of the Attraction 204 from External Data Source 402, such as publicly available pamphlets of each Attraction 204 and various websites on the Internet 404, such as Wikipedia or Wikitravel. Attraction Data 406 may be stored internally and used to train a model for the Attraction Scoring Module 410.

User Preference Module 412 calculates the preference of Attractions 204 of a User 212 into a numeric score. This score is calculated from User History Data 408, such as User's 212 past Trip 214 recorded in the system, or information collected from Internet 404, such as a social media website Facebook. These data may be stored internally and used to train a model for the User Preference Model 412. System currently uses uniform score for all the Attractions 204 given a User 212.

The scores generated by Attraction Scoring Module 410 and User Preference Module 412 will be combined at Combination Module 416. Current system considers outputs of Attraction Scoring Module 410 and User Preference Module 412 as probabilities and multiplies the two scores. The Attraction Rank 416 is created by sorting the Attractions 204 by the combined score.

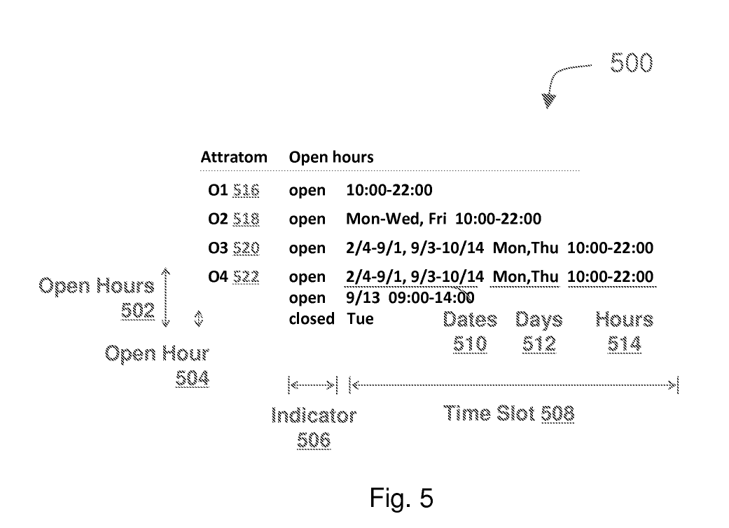

FIG. 5 describes Open Hours 502 text used in our system. We normalized the format of the conventional open hours text found in various websites and pamphlets to make it available for automatic processing. An Open Hours 502 text consists of multiple lines of Open Hour 504 text and each Open Hour 504 text consists of two parts: Indicator 506 and Time Slot 508. FIG. 5 shows an example of Open Hours 502 text and a single line Open Hour 504 text with some Attratom O1, O2, O3, and O4.

Indicator 506 determines whether the Attraction 204 or Attratom 206 is open/closed during the time defined in the Time Slot 508. Time Slot 508 defines when an Open Hour 504 line is valid. Time Slot 508 consists of three subparts: Dates 510, Days 512, and Hours 514 and each subpart is expected to repeat over time. For instance, Dates 510 repeats over years. Dates 510 defined “2/4-9/10” is expected to be valid between February 4th and September 10th of every year. Similarly, each Days 512 and Hours 514 repeats over weeks and days. Only one or two among three subparts may be defined, meaning that a Time Slot 508 may only have Days 512 and Hours 514 condition defined. The more Time Slot's 508 subpart is defined, the stricter the Time Slot 508 becomes. For instance, Attratom O1 516 in FIG. 5 opens every day between 10 AM and 10 PM while Attratom O3 520 opens between 10 AM and 10 PM only on Mondays and Wednesdays.

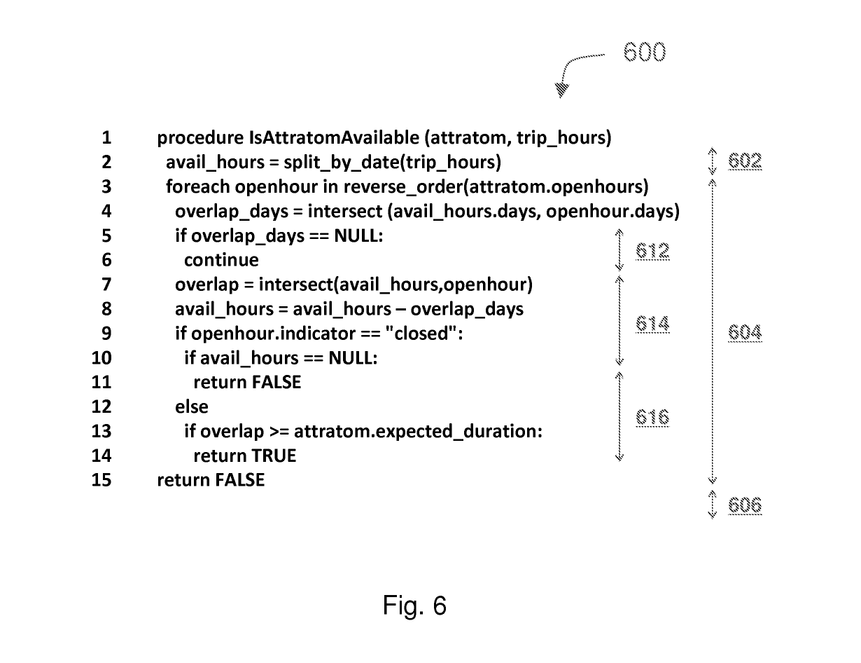

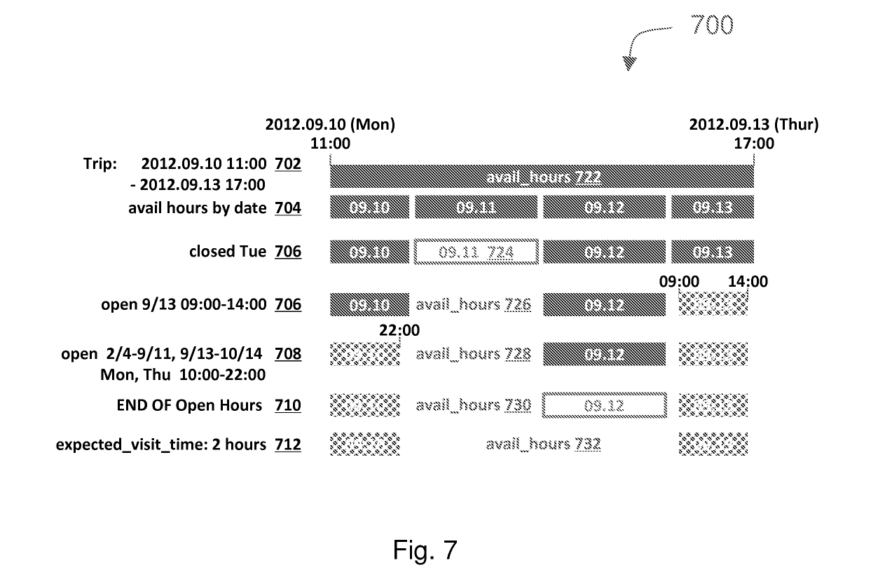

FIG. 6 describes the basic algorithm used in Open Hours Check Module 320 written in python-like pseudo-code and FIG. 7 shows an example run of this Algorithm using Attratom O4 in FIG. 5. The algorithm works as follows. First, the Trip's 214 TripHours 218 are split into each dates 602. Then, for each Open Hour 504 in Open Hours 502 in the order of bottom to top, the Open Hour 504 checks whether there is any date in TripHours 218 that satisfies Open Hour's 504 Dates 510 and Days 512 condition. For each date in TripHours that satisfies Open Hours's 504 Dates 510 and Days 512 condition, Hours 514 condition is intersected with the Trip's 214 avail_hours of the date. If the intersection is longer than given Attratom's 206 expected duration, the Attratom 206 is considered visitable. Otherwise, algorithm continues to the next Open Hours 504 line. At the end of the algorithm, if there is no more Open Hour 504 to check, the Attratom 206 is considered not visitable

Open Hours 502 is scanned from bottom to top because the bottom Open Hour 504 always overwrites the result from top Open Hour 502 and the algorithm can always success-fast if run from bottom to top. TripHours 218 are split into each date of TripHours 218 because matching of TripHours 218 and Open Hours 502 is done on date level. For instance, in FIG. 7, avail_hours of September 13 is 09:00-14:00 because September 13 is matched at line 706 and 708, but the second Open Hour 504 overwrites the first.

After deciding each Attratom's 206 availability during the Trip 316, the Itinerary Builder Module 318 continues to next module, Cheapest Ticket Combination Module 322 with the available Attratoms 206 from Open Hours Check Module 320.

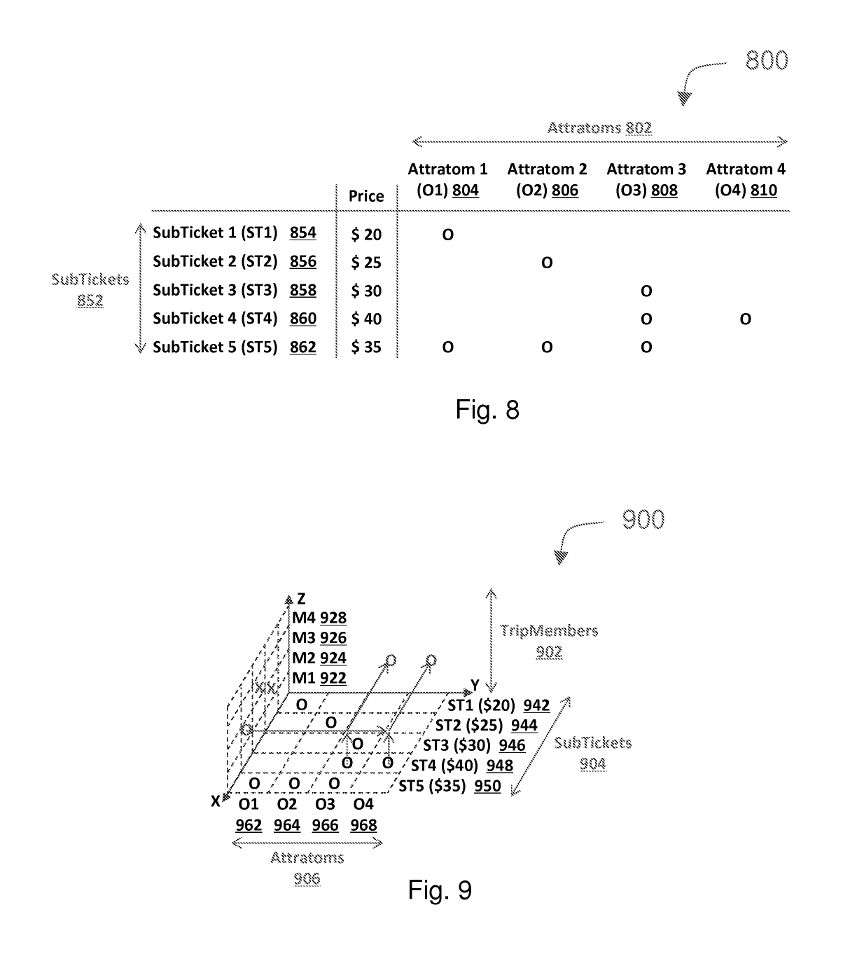

Cheapest Ticket Combination Module 322 finds the cheapest combination of tickets that can cover all the Attratoms 204 the User 212 wants to visit during a Trip 316. FIG. 8 shows a simple example of a Trip 316 with Attratoms 802 to visit on the columns of the table, and SubTickets 852 that cover any of the Attratoms 204 on the rows of the table. Circles show which Attratoms 802 are covered by each SubTicket 852. For instance, with SubTicket 4 860, you can enter Attratom 3 808 & 4 810.

From the table in FIG. 8, you can see that the goal of the system is to choose a subset of SubTickets 852 (or rows) that has at least one circle for each Attratom 802 (or column) and cover all the Attratoms while keeping the price as low as possible. For instance, choosing SubTicket 1 854 and 4 860 fails to cover all the Attratoms 802 since Attratom 2 806 is covered neither by SubTicket 1 854 nor by SubTicket 4 860. Choosing SubTickets 1 854, 2 856, and 4 860 covers all the Attratoms 802 but this is suboptimal because the cost, $85, is more expensive than choosing SubTickets 4 860 and 5 862, which costs $75. By choosing SubTickets 4 860 and 5 862, the User 212 gets admissions to Attratom 3 808 twice, but that does not matter as long as all the Attratoms 802 are covered by selected SubTickets 852.

If you view each SubTicket 852 as a set of tourist attractions to which the SubTicket 852 has admission, and price as the weight of each set, cheapest ticket combination problem becomes an optimization version of a set cover problem. A set cover problem can be defined as follows: given a set N and M, where M={(x,w)|xε2^{N}, wε [symbol] }, and a function sum(K), where sum(K)=Σ_{(x,w)εK}w, a set cover problem tries to find a set S⊂M, s.t. U_{sεS}=N, while there is no other set S′⊂M s.t. U_{sεS′}=N and sum(S)>sum(S′). A set cover problem is a well-known NP-hard problem and does not have a polynomial-time solution, but we could solve a ticket optimization problem in practical amount of time, faster than simple exhaustive search approach, after converting it into an integer programming (IP) problem. We will talk more about this later.

Trivial approach to multiple people ticket optimization is to run single person ticket optimization multiple times. However, some tickets, such as group tickets, make trip members to be dependent on each other and make it impossible to optimize each person independently.

FIG. 9 shows a simple example of cheapest ticket combination problem with multiple people. Compared to FIG. 8, the chart has Z-axis for TripMembers 902. X-Y planes define which Attratoms 906 each SubTicket 904 covers as in FIG. 8, while X-Z plane shows which TripMember 902 will be using which SubTicket 904. Some SubTickets 904, such as a student ticket or a senior ticket, are not available for some trip members and ‘X’ marks on the X-Z plane represent it. For instance, in FIG. 9, M2 924 cannot buy SubTicket ST2 944.

The Attratom coverage of each selected SubTicket, represented as ‘O’ mark on X-Y plane, can be understood as follows; as in FIG. 9, ‘O’ marks on X-Z plane will be projected onto Y+ side and each ‘O’ marks on X-Y plane will be projected onto Z+ side. When these two projections meet, we can mark ‘O’ to the related cell on Y-Z plane, and the goal of the ticket optimization problem with multiple trip members becomes marking all cells in Y-Z plane with ‘O’ mark, by marking cells in X-Z plane while keeping ticket cost as low as possible. Ticket optimization of multiple people is implemented using Semaphores, which works similarly to the Semaphores used in Operating Systems in the field of Computer Science

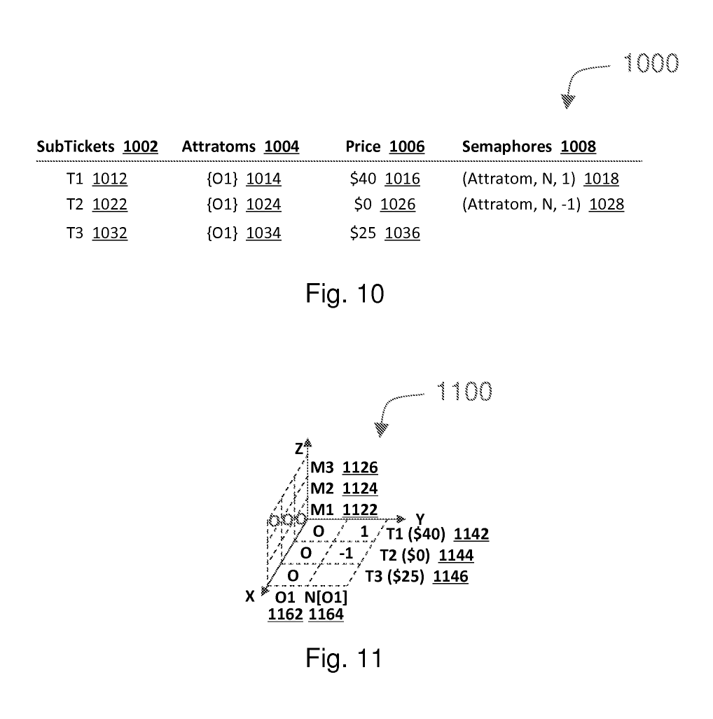

Semaphore is a variable that can be added to each SubTicket 210 in the format of (domain parameter, semaphore name, integer), as shown in FIG. 10. FIG. 11 shows how Semaphores are processed by the system. Domain parameter ‘Attratom’ in both ticket T1 1012 and T2 1022 in FIG. 10 is determined to domain name ‘O1’ as ‘N[O1]’ 1164 in FIG. 11, following the Attratom each ticket is related to. Each domain name and semaphore name gets its own column on Y-Axis of FIG. 11. Similar to variables defined inside a function in programming languages, only Semaphores with identical domain names and semaphore names are treated as identical Semaphores during optimization.

When calculating optimal ticket combination, selected set of SubTickets 210 is valid only if summed values of all Semaphores among selected SubTickets 210 become non-negative. For instance, assume two people are planning to visit A1 1014 in FIG. 10. Both TripMembers 220 choosing T2 1022 is one possible solution, but this solution is invalid since value of semaphore ‘N[A1]’ 1164 becomes −2. Both TripMembers 220 choosing either ticket T1 1012 or T3 1032 is a valid ticket combination with semaphore value of ‘N[A1]’ 1164 becoming 0 or 4. However, the cheapest solution is achieved when one member chooses T1 1012 and the other member chooses T2 1022. This way all the Attratoms are covered, and all Semaphore values stay non-negative (N[A1]=+1−1=0), while the total cost is only $40, less than buying two T1 1012 or T3 1032 tickets.

To process SubTickets 210 with person-dependent features, system asks the user a priori whether each TripMember 220 belongs to a special group, such as student, senior, or veteran. Then, system creates Semaphores 1008 to ensure that only people belonging to the group can buy group dependent ticket. For instance, by providing semaphore (member, student, ∞) to each student TripMember 220, and adding semaphore (member, student, −1) to each student SubTicket 210, system can force student tickets to be bought only by students.

Some features, such as membership to an Attraction 204, are attraction-dependent and the User 212 will be asked whether each TripMember 220 belongs to these attraction-dependent features when an Attraction 204 is added to the User's 220 Trip 214.

For optimization with group tickets, Semaphores 1008 are used to model interaction between TripMembers 220. Group ticket has two subtypes; a group ticket which requires precise number of people, (‘type 1’ group ticket; i.e. a couple ticket where precisely two adults are required) and a group ticket which additional participants can get discount as long as the group has more people than certain number (‘type 2’ group ticket; i.e. a family ticket of two adults and one children where you can purchase admission for additional children with additional cost).

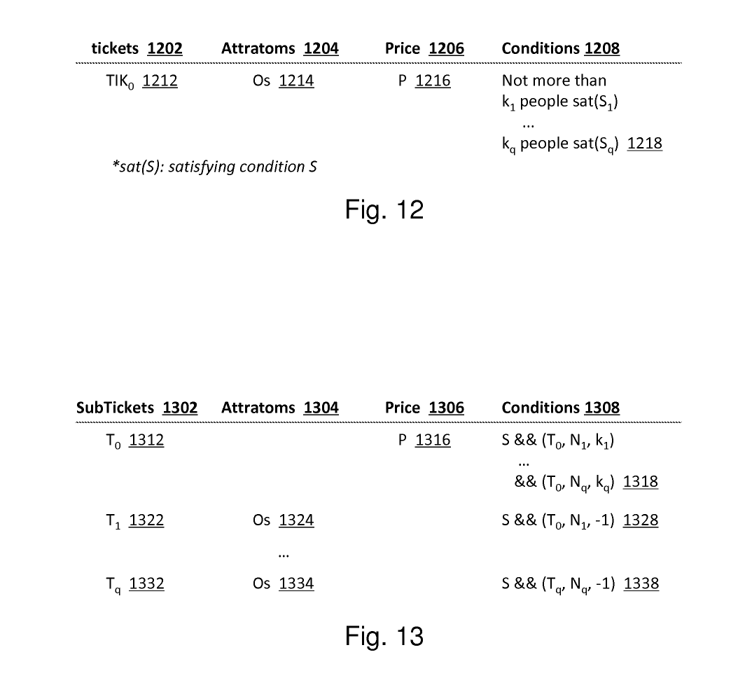

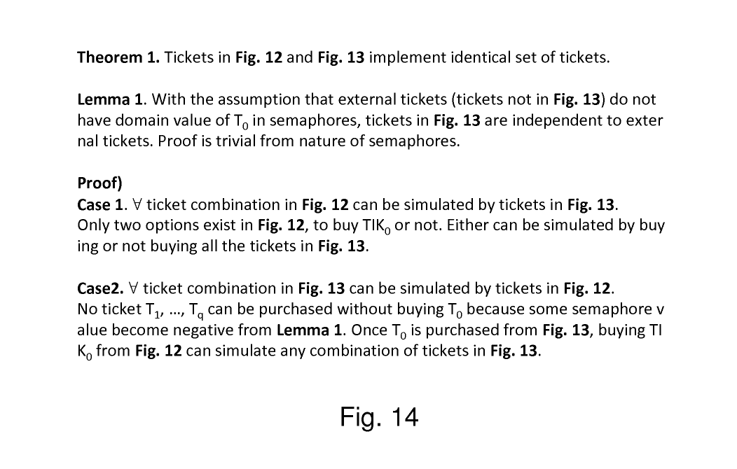

FIG. 12 shows generalized form of a type 1 group ticket. Purchasing ticket TIK₀ 1212 grants admission to k₁ people who satisfy condition S₁, k₂ people who satisfy condition S₂, . . . , and k_{q} people who satisfy condition S_{q} 1218. Using Semaphores, we can implement TIK₀ 1212 as described in FIG. 13. T₁ 1322 to T_{q} 1332 are SubTickets 210 that grants admission to each type of participants mentioned in TIK₀ 1212, and T₀ 1312 generates semaphores that allow the TripMembers 220 to purchase right amount of T₁ 1322 to T_{q} 1332 tickets. Proof of equality between tickets in FIG. 12 and SubTickets 1302 in FIG. 13 is described in FIG. 14. Single type 1 group ticket in FIG. 12 expands into O(q) SubTickets and Semaphores as in FIG. 13, where O( ) is the big-O notation in the field of Computer Science. Since q is the number of types of people in the group, which is generally small, the expansion is not burdensome.

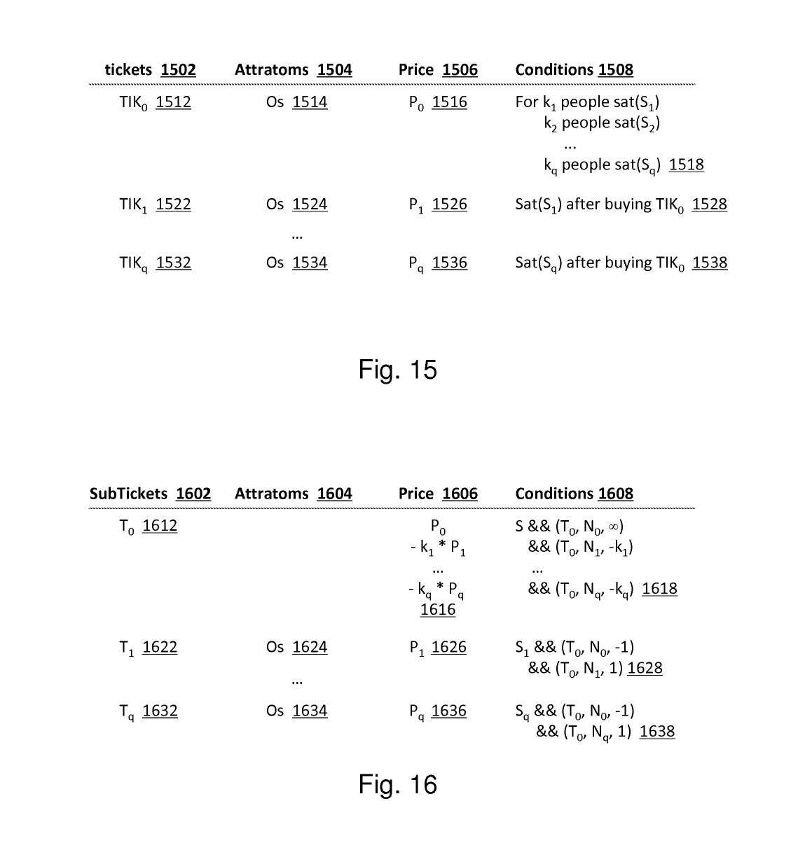

FIG. 15 shows generalized form of a type 2 group ticket. TIK₀ of FIG. 15 is identical to TIK₀ of FIG. 12. However, FIG. 15 has q more tickets that allow purchase of additional tickets for people satisfying each condition. FIG. 16 shows implementation of tickets in FIG. 15 using Semaphores. Proof of equality between tickets in FIG. 15 and FIG. 16 is similar to proof in FIG. 14. Single type 2 group ticket in FIG. 15 expands into 0(q) tickets and semaphores as in FIG. 16.

Some group tickets have mixed properties of both type 1 and type 2 group tickets in a single ticket. For instance, family tickets often require exactly two adults while children can be added to the family ticket as many as desired. These group tickets of mixed properties can be implemented by properly mixing Semaphore structures of each type.

A select-N ticket lets a person visit any one attratom among multiple attratoms covered by the ticket. Combination tickets often have select-N property within the ticket. For instance, you can choose to enter any single attratom between Top of the Rock and Guggenheim Museum with the purchase of NYCP.

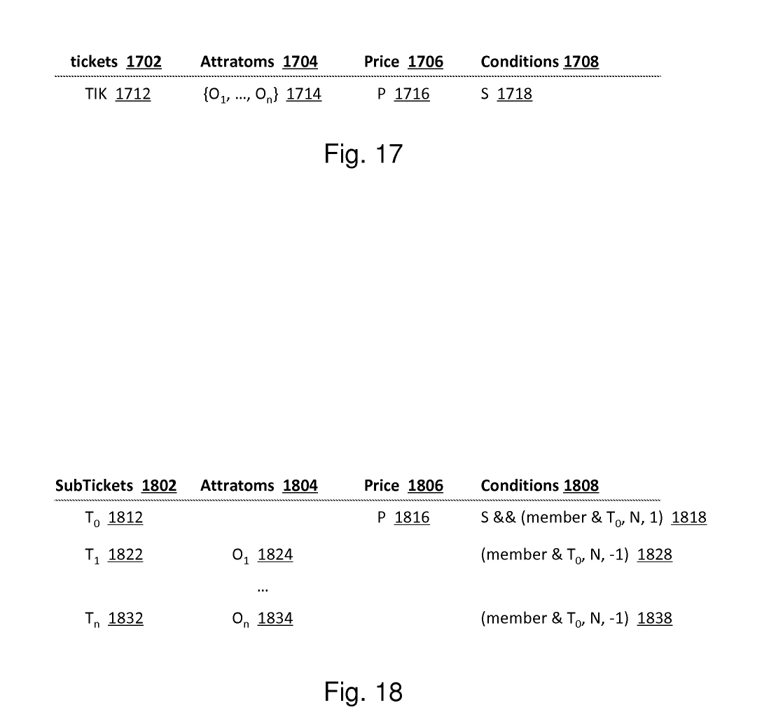

FIG. 17 shows generalized form of a select-N ticket and FIG. 18 shows select-N ticket implemented using SubTickets 210 and Semaphores. ‘member’ parameter is added to semaphore's domain parameter, a parameter reflecting the person who buys this SubTicket 210, to make semaphores of select-N tickets independent across TripMembers. Proof of equality between tickets in FIGS. 17 and 18 is similar to the proof in FIG. 14. Single select-n ticket in FIG. 17 expands into O(n) tickets and semaphores as in FIG. 18 when n is the number of attratoms covered by a select-N ticket. ‘n’ can be the number of all Attratoms 204 in worst case, but practically, n is a small number less than 4 and this expansion is not burdensome.

Time dependent tickets are tickets that can be used only during a certain time range. For instance, Museum of Modem Art has free tickets on Friday after 3 pm. These tickets can appear under many different conditions, such as “after 2 pm”, “before 1:30 pm”, and etc, and it is impossible to consider all these conditions as they are. Nevertheless, some algorithm is required to avoid collision among time-dependent tickets, a situation where two time-dependent tickets are trying to take the same time slot, and Pigeonhole Principle is used to solve this problem.

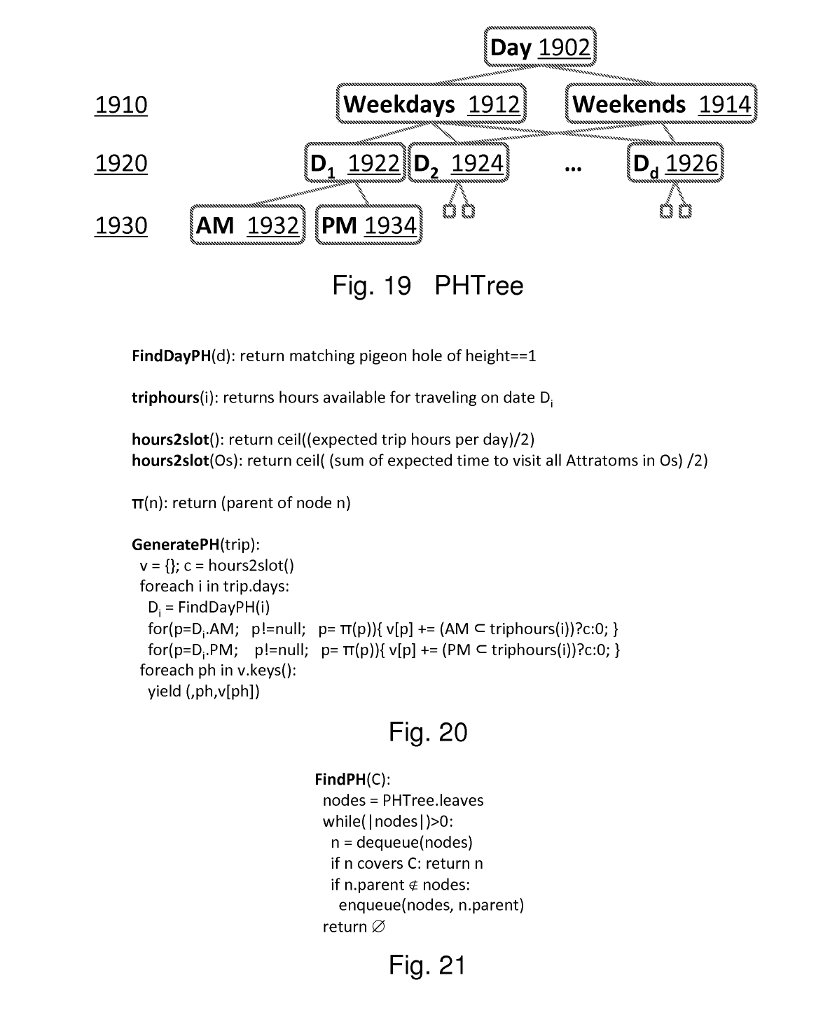

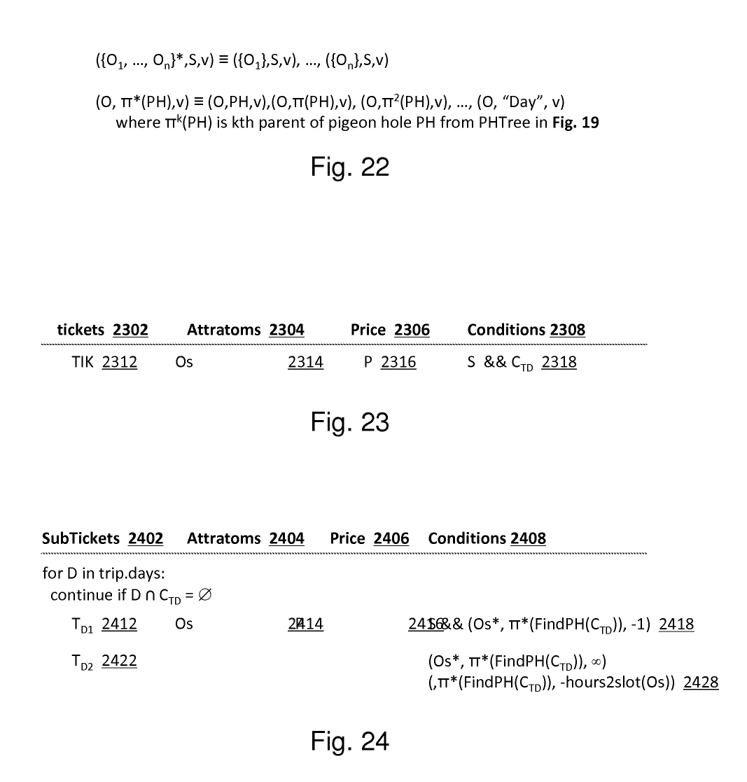

FIG. 19-24 describes implementation of time dependent ticket using semaphores. First, pigeon holes are structured hierarchically as in FIG. 19. Pigeon holes are created for each Day of the trip 1920 and AM/PM of each day 1930. Weekday and weekend pigeon holes 1910 are created as parent of each day (Dᵢ) pigeon hole, and “Day” pigeon hole 1902 is created at the root of the tree.

At the beginning of the optimization process, global pigeon hole semaphore values, which represent how many attratoms can be visited for each pigeon hole, is generated as in FIG. 20. For instance, if a trip is from Day 1 10 am to Day3 8 am, pigeon hole values of v[Day1.PM], v[Day2.AM], v[Day2.PM] becomes c and the values are summed up following the PHTree in FIG. 19. Algorithm generates O(d) semaphores and takes running time of O(d) where d is the number of travel days usually less than 7.

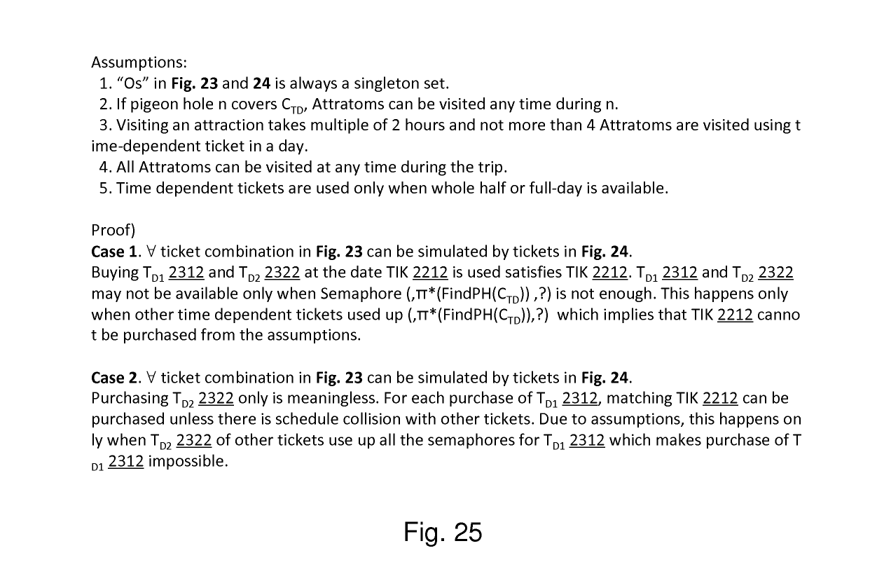

FIG. 23 describes generalized form of a time dependent ticket with time dependent condition C_{TD}. FIG. 24 shows how a time dependent ticket in FIG. 23 can be implemented using semaphores. Ticket T_{D1} 2412 in FIG. 24 is equivalent to TIK 2312 in FIG. 23 except that T_{D1} requires proper semaphore values. Ticket T_{D2} 2422 consumes pigeon hole values initialized at FIG. 20 and reserves a time slot for attratoms covered in T_{D1} 2412.

FIG. 25 shows proof of equality between tickets in FIGS. 23 and 24. Several realistic assumptions are made for simple and clear proof. Assumption 1 is based on the fact that all time dependent tickets in New York City have only single attratom. Assumption 2 and 4 is made because in most cases travelers can reorder their schedule or hurry up to visit the tourist attratoms at the right time. Assumption 3 relies on the fact that transport between tourist attratoms takes time and this time can fit into visit time of either previous or latter attratom. Assumption 5 matters only at the start date or end date of the trip when whole half or full-day schedule is not available. Given that schedule can become tentative when entering or leaving a city, refraining from using time dependent ticket on trip start or end date makes sense. Single time dependent ticket in Table 12 expands into O(1) tickets and semaphores in FIG. 24.

A day-pass tickets is another common ticket form. A day-pass ticket allows a person to visit multiple attratoms covered by the ticket within fixed length of dates after ticket activation. For instance, New York Pass (NYP) ticket covers more than 50 tourist attratoms in New York City and the ticket holder can visit as many attratoms covered by the ticket as long as you visit these tourist attratoms in 1, 3, or 5 days following the type of the day-pass ticket.

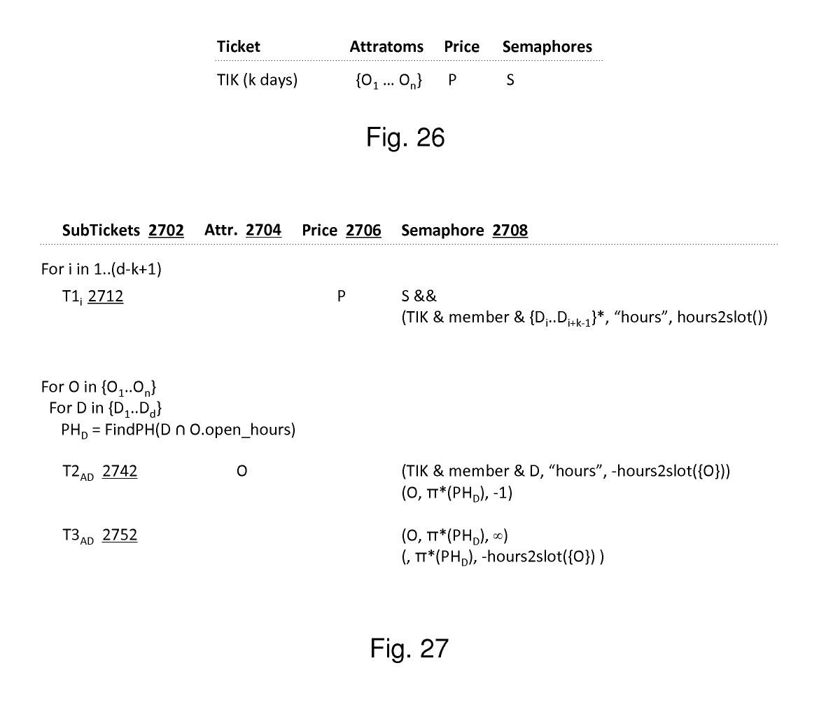

FIG. 26 shows generalized form of a day-pass ticket and FIG. 27 shows implementation of a day-pass ticket using semaphores. Buying a day-pass ticket of k days covering n attratoms is treated as buying a time dependent ticket for each attratom available only for a single day among k days. To prevent making any infeasible schedule, −hours2slot{O}) in T2_{AD} 2742 regulates number of attratoms visitable per day using the daypass ticket and pigeon hole semaphores of T3_{AD} 2752 makes all TripMembers 220 to have same trip itinerary. Proof of equality between tickets in FIGS. 26 and 27 is similar to proof in FIG. 25. From single day-pass ticket, O(d*|O|) semaphores and tickets are generated when d is the number of trip days and |O| is the number of attratoms covered by the day pass. While d is likely to be fairly small, |O| can become fairly large, as in case of NYP.

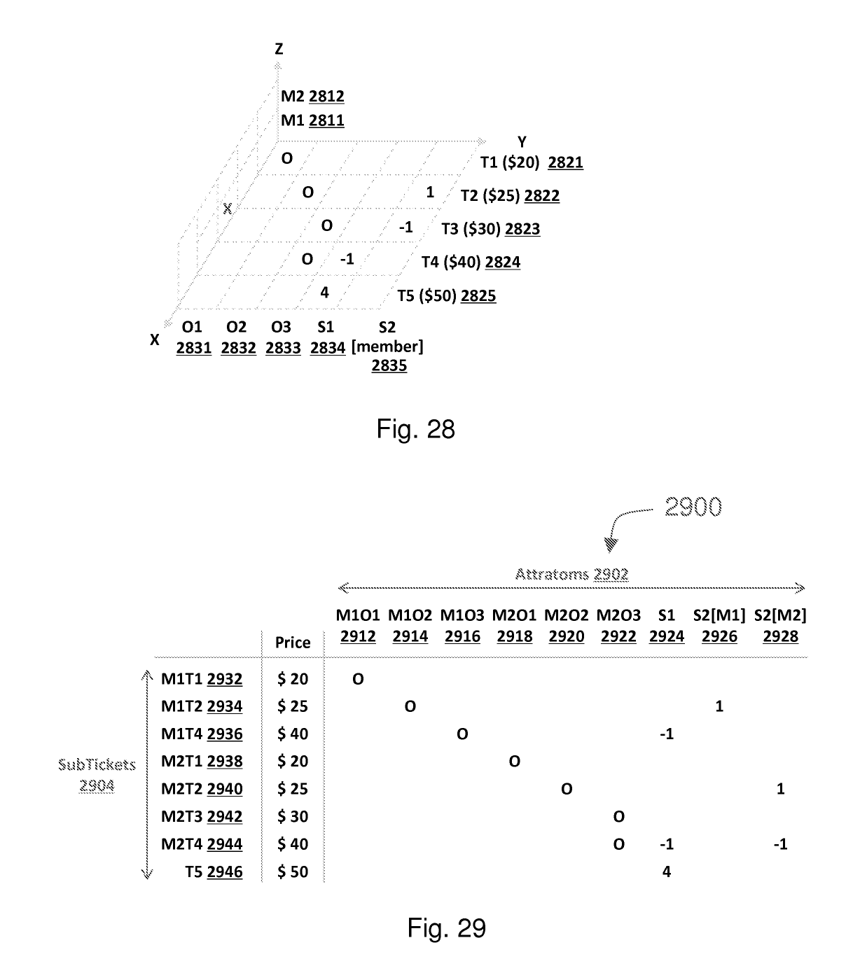

Following paragraphs describes how system converts a set cover problem into IP problem. Unlike regular member-dependent tickets, where each person can buy separate instance of same ticket, some member-independent tickets, such as T3_{AD} 2752 in FIG. 27, requires only one ticket instance among multiple trip members. To make optimization universal across member dependent and independent tickets, a 3-D model, as in FIG. 28, is converted into a 2-D model without member axis an in FIG. 29. Member information is incorporated into each member-dependent ticket, attratom, and semaphore in 2-D model. For instance, in case of FIGS. 27 and 28, T1 changes to M1T1 & M2T1, O1 to M1O1 & M2O1, and S2[member] to S2[M1] & S2[M2]. Member-independent tickets and semaphores, T5 and S1, stay unchanged.

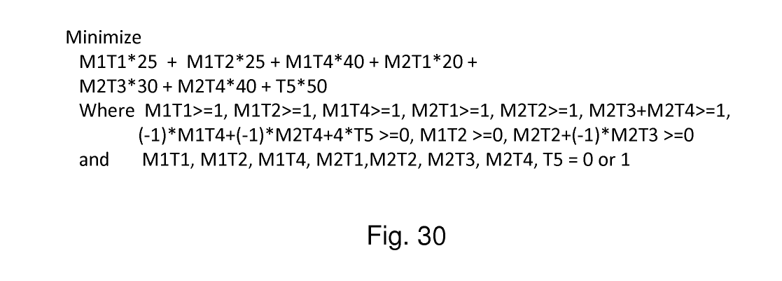

Conversion of a set cover problem to IP problem is already known, and FIG. 30 shows optimization equations from FIG. 29. Optimization equation is to minimize the total cost of the tickets when each ticket variable, i.e. M1T1 or T5, can take value of 0 or 1. The condition equations are to keep sum of each attratom/semaphore column larger than or equal to 1/0. Recovering solution of set cover problem from IP problem is trivial and well known, and we can easily figure out the tickets that each trip member has to buy.

Although the preceding description contains significant detail, it should not be construed as limiting the scope of the invention but rather as providing illustrations of the preferred embodiments of the invention. As an example, the domain model of the invention could take many different forms. One alternative would be making TripOptimization 215 as an attribute of Trip 214 object instead of a stand-alone object. Such a variation would not materially alter the nature of the invention. Thus, the scope of the invention should be fixed by the following claims rather than any specific examples provided.

TABLE 1

| | Attratoms | | |
|---|---|---|---|
| Tickets | 86^{th} floor | 102^{nd} floor | express pass |
| 86^{th} floor | O | | |
| 86^{th} floor express | O | | O |
| 86^{th} & 102^{nd} floor | O | O | |
| 86^{th} & 102^{nd} floor express | O | O | O |

What is claimed is:

1. A system for configuring a travel itinerary for a user, comprising:
a computerized user device with a user interface communicating with a network, wherein the computerized user device is capable of receiving information relative to a trip, wherein the received information comprises a destination, a trip hours, and a trip member information;
a travel content provider in communication with a computerized data source capable of supplying a plurality of attraction information based on the received information, wherein the attraction information comprises a location and an open hour of an attraction; and
an itinerary creation engine capable of generating a plurality of travel itineraries from the travel content provider to the computerized user device based on the received information and the attraction information, the itinerary creation engine in communication with the computerized data source, wherein the generated itinerary comprises at least the trip hours and the attraction information.

2. The system of claim 1 wherein the attraction information further comprises a plurality of attratoms and a plurality of tickets, wherein a first portion of an attraction corresponds to a first attratom, the first attratom comprising an open hour of the first portion of the attraction and an expected duration of the first portion of the attraction, and the first attratom corresponding to a first ticket comprising a price of the first ticket and a semaphore of the first ticket, a second portion of the attraction corresponding to a second attratom comprising the open hour of the second portion of the attraction and the expected duration of the second portion of the attraction, and the second attratom corresponding to a second ticket comprising a price of the second ticket and a semaphore of the second ticket.

3. The system of claim 2, further comprising an itinerary builder module in communication with the itinerary creation engine, capable of optimizing the generated travel itinerary based on the price of each ticket, a number of attratoms, and the expected duration of each attatrom.

4. The system of claim 1, wherein the trip member information comprises information relative to a profile of a plurality of travelers, the profile comprising of an age and an occupation of each of the plurality of travelers.

5. The system of claim 4, wherein the attraction information further comprises a plurality of sub tickets, each sub ticket identified by the travel content provider based on the trip member information wherein each sub ticket comprises a price of the sub ticket and a semaphore of the sub ticket, a purchase of each sub ticket is limited by the semaphore of each sub ticket and the price of each sub ticket is based on the trip member information.

6. The system of claim 3, further comprising:
a computerized attraction ranking module, in communication with the itinerary builder module, capable of scoring the attraction on the basis of an attraction scoring module and a user preference module, wherein a first score is assigned to the attraction by the attraction scoring module, and a second score is assigned to the attraction by the user preference module based on a traveler's past trip, the itinerary builder module capable of optimizing the generated travel itinerary further based on the scoring.

7. The system of claim 6, wherein the attraction ranking module ranks the attraction based on information collected from the computerized data source.

8. The system of claim 1, wherein the ticket allows admission to a plurality of attractions.

9. The system of claim 1, wherein the itinerary creation engine is further capable of identifying a text description of the open hour of the attraction from a website of a travel content provider.

10. A method for optimizing a travel itinerary for a user, comprising the steps of:
receiving information relative to a trip from the user by at least one computer, wherein the received information comprises a destination, a trip hours, and a trip member information;
collecting, by the at least one computer, an attraction information based on the received information from a travel content provider, wherein the travel content provider is in communication with the at least one computer, the attraction information comprising a location and an open hour of an attraction;
receiving the attraction selected by the user;
generating a plurality of travel itinerary by an itinerary creation engine, of the at least one computer, based on the attraction information and the received information, wherein the generated itinerary comprises the trip hours and the attraction information; and
ranking the generated travel itinerary based on the attraction information using an itinerary builder module by comparing the generated travel itinerary to the received information wherein the itinerary builder module is in communication with the at least one computer.

11. The method of claim 10, wherein the step of collecting an attraction information further comprises collecting a plurality of attratoms and a plurality of tickets, wherein a first portion of an attraction corresponds to a first attratom comprising an open hour of the first portion of the attraction and an expected duration of the first portion of the attraction, and the first attratom corresponds to a first ticket comprising a price of the first ticket and a semaphore of the first ticket, a second portion of the attraction corresponds to a second attratom comprising the open hour of the second portion of the attraction and the expected duration of the second portion of the attraction, and the second attratom corresponds to a second ticket comprising a price of the second ticket and a semaphore of the second ticket.

12. The method of claim 11, wherein the step of ranking the generated travel itinerary based on the attraction information comprises ranking the generated travel itinerary based on the price of each ticket, a number of attratoms, and the expected duration of each ticket.

13. The method of claim 10, wherein the step of collecting an attraction information further comprises collecting a plurality of sub tickets, each sub ticket is identified by the travel content provider based on the trip member information wherein each sub ticket comprises a price of the sub ticket and a semaphore of the sub ticket, a purchase of each sub ticket is limited by the semaphore of each sub ticket and the price of each sub ticket is based on the trip member information comprising of a profile of a plurality of travelers wherein the profile comprises an age and an occupation of each traveler.

14. The method of claim 13 wherein the step of ranking the generated travel itinerary based on the attraction information comprises ranking the generated travel itinerary based on the price of each sub ticket.

15. The method of claim 10 wherein the step of ranking the generated travel itinerary comprises ranking the attraction on the basis of an attraction scoring module and a user preference module by scoring the attraction, wherein a first score is assigned to the attraction by the attraction scoring module and a second score is assigned to the attraction by the user preference module based on a traveler's past trip.

16. The method of claim 15 further comprising the step of:
determining an attraction rank using a combination module wherein the attraction rank is determined by multiplying the first score and the second score, the combination module is in communication with the at least one computer.
